(19) United States
(12) Patent Application Publication
(10) Pub. No.: US 2009/0215502 A1
(43) Pub. Date: Aug. 27, 2009

(54) WIRELESS HEADSET WITH RECORD FUNCTION

(76) Inventor: Paul P. Griffin, JR., Nashville, TN (US)

Correspondence Address: HORNKOHL INTELLECTUAL PROPERTY LAW, P.L.L.C, P.O. BOX 210584, NASHVILLE, TN, 37221, US

(21) Appl. No.: 12/390,207

(22) Filed: Feb. 20, 2009

Related U.S. Application Data
(60) Provisional application No. 61/030,230, filed on Feb. 21, 2008.

(51) Int. Cl. H04M 1/00; H04R 11/04

(52) U.S. Cl. 455/569.1; 381/361

(57) ABSTRACT

A portable headset voice recorder that enables wireless two way voice communications between the headset and a mobile phone has an ear grip that grips an ear of a user. A housing mounted on the ear grip has a microphone, a speaker, a display and a user input. A digital memory enclosed with the housing records audio samples from the microphone in response to a user manipulating the user input. A global positioning system determines location information corresponding to the recorded audio samples. A clock generates a time stamp associated with the audio sample. The headset has a USB port that is used to recharge the headset and transfer the recorded files and associated metadata to a computer. Application software residing on the computer allows a user to review and manipulate the files and program the headset to trigger playbacks and records.

### CROSS-REFERENCES TO RELATED APPLICATIONS

The present application claims priority, from co-pending U.S. Provisional Patent Application Ser. No. 61,030,230 filed Feb. 21, 2008 entitled “BLUETOOTH RECORDER”.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

Bluetooth is a wireless protocol for exchanging data over short distances between fixed and mobile devices. It can be used to connect several types of devices and is standardized to overcome problems of synchronization. Bluetooth headsets are frequently used to wirelessly transfer digital audio data from a mobile phone to a pair of headphones or earphones.

Digital audio note recorders that record a user's voice in response to the user activating a record function are also well known. Unfortunately, these devices require the user to carry the device with them and have limited functionality.

### BRIEF SUMMARY OF THE INVENTION

The present invention is directed toward a portable headset that enables wireless two way voice communications between the portable headset and a mobile phone. The portable headset has an ear grip that grips an ear of a user. A housing is mounted on the ear grip. A microphone and speaker are positioned on the housing. The housing also has a display and a user input mounted on its exterior. A digital memory enclosed with the housing records audio samples from the microphone in response to a user manipulating the user input. A global positioning system determines location information corresponding to a recorded audio sample. A clock generates a time stamp associated with the audio sample. The metadata is recorded in the memory. A male USB port allows a rechargeable battery of the headset to be recharged by coupling the USB port to a computer. Application software residing on the computer downloads recorded audio files from the headset to the computer through the USB port. The user can then review the audio samples and metadata on the computer and use the software to program the headset

Another embodiment of the present invention is directed toward a portable headset that enables wireless two way voice communications between the portable headset and a mobile phone. The portable headset includes a voice recorder that records an audio sample in response to manipulation of a user input on the headset. The microphone and speaker for the headset are removably coupled through cables and jacks to a housing that contains the voice recorder and a global positioning system receiver.

### BRIEF DESCRIPTION OF THE SEVERAL VIEWS OF THE DRAWINGS

FIG. 1 is an illustration of a voice recording system constructed in accordance with an embodiment of the invention;

FIG. 2 is a functional block diagram of the an embodiment of the present invention; and

FIG. 3 is an illustration of an alternative embodiment of the present invention having the microphone and speaker removably coupled to the voice recorder.

### DETAILED DESCRIPTION OF THE INVENTION

The present invention is directed toward a Bluetooth headset with a voice recorder that charges over USB and acts like a USB storage device for file storage and voice note retrieval. The headset allows a user to receive an incoming phone call, answer it with his Bluetooth headset, and have a conversation and then hang up. The user can then activate the voice recording feature and make notes about the conversation they just had. The user can then review the voice notes at a later time by activating the voice note playback to listen to the notes. A variety of metadata including location, time and associated phone number concerning the voice note is stored in the device. Detailed note details can be retrieved through an interface on the headset or on a personal computer by downloading the data to the computer through the headset's USB port.

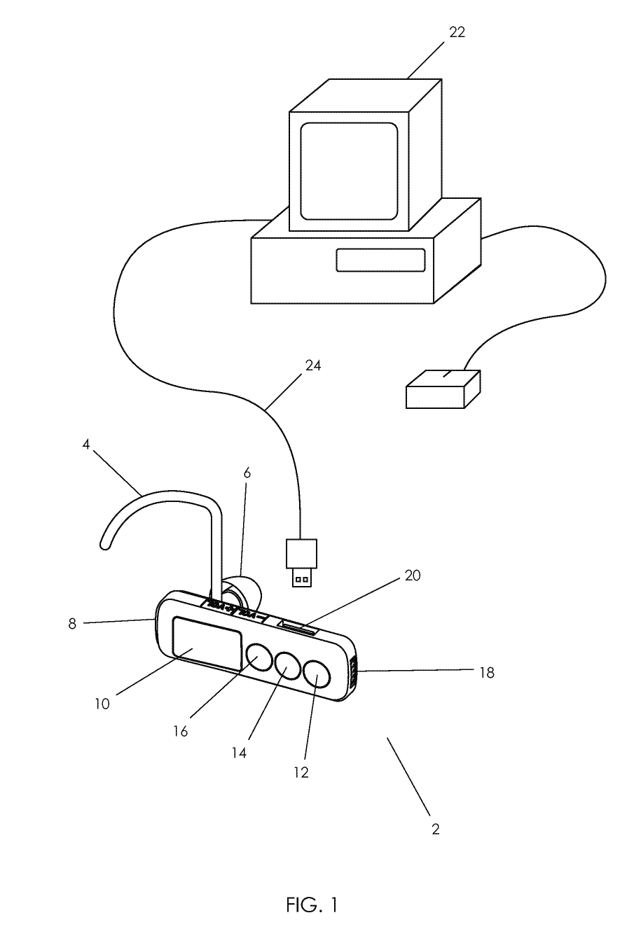

Referring now to FIG. 1, an illustration of a voice recording headset 2 constructed in accordance with an embodiment of the invention is shown. The electronics housing 8 of the voice recording headset 2 is connected to an ear grip 4 that holds the headset 2 on the ear of a user. An ear bud 6 having an internal speaker for insertion into a user's ear is mounted on the housing 8. The electronics housing 8 contains the electronics necessary to implement the functions described herein. The electronics housing 8 has an LCD display 10, a note record button 12, a note playback button 14 and a Global Positioning System (GPS) button 16 mounted on its exterior. A microphone 18 is included on the headset 2 for recording audio in response to user inputs. A USB port 20 on the electronics housing 8 allows the headset 2 to be coupled to a computer 22 through a standard USB cable 24. This allows the transfer of data between the headset 2 and computer 22 and the recharging of a rechargeable battery in the headset 2. The head set 2 provides USB storage capabilities and acts as a standard USB hard drive when plugged into the USB port of the computer 22 such that files can be copied to and from the device.

The LCD display 10, or other similar small indicator, on the headset 2 shows how many voice notes have been recorded and allows a user to select through the buttons 12, 14 and 16 which memo to play back. Additional data can be displayed as desired. While the embodiment of FIG. 1 uses the buttons 12, 14 and 16 shown, the particular buttons, or button combinations, required to select any particular feature is matter of design choice. In alternative embodiments, the recording may be controlled by touching the headset 2 or through voice activation. Recording can be automatically deactivated after a certain amount of detected ‘silence’. The playback speed of the messages can preferably be increased or slowed down with out affecting the pitch of the audio.

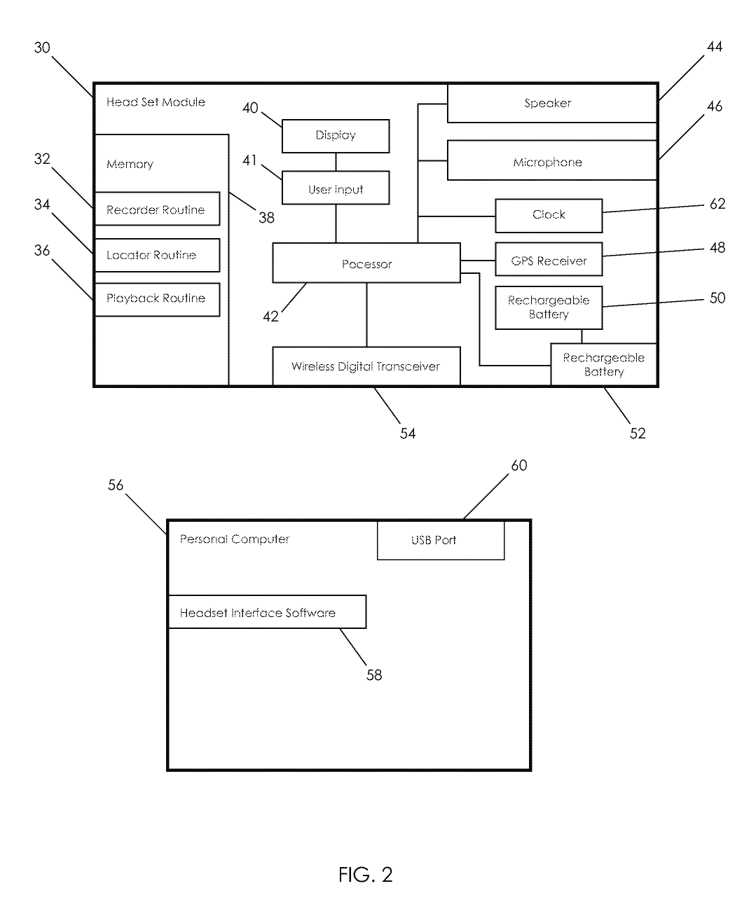

Referring now to FIG. 2, a functional block diagram of the embodiment of the present invention is shown. The headset 30 device includes a wireless digital transceiver 54 with an antenna that enables 2 way voice conversations through a mobile phone using a standard wireless protocol such as the Bluetooth standard ‘headset profile’. The functions of the head set module 30 are controlled by a processor 42. The processor 42 manages a speaker 44 and microphone 46 to record and playback voice notes in response to manipulation of a set of user inputs 41. The processor 42 communicates information to the user through a display 40. A digital memory 38, preferably a solid state flash memory, contains the recorded voice notes. The digital memory 38 also contains the recorder 32, locator 34 and playback 36 software routines needed by the processor 42 to implement the recording, locating and playback functions described herein

A GPS receiver 48 allows the headset 30 to record geospatial information associated with a voice note in the memory 38. The processor 42 can be programmed by the user to playback a selected message when the GPS receiver 48 detects the headset 30 has entered a particular area so that playback can occur automatically when the user reaches the selected location. For example, a user can set up automatic playback of a note containing a shopping list when the user enters their usual supermarket, as previously programmed into the headset 30. A clock 62 is included in the headset 30 so that the audio files created can also be time and date stamped.

The GPS and time information is preferably used in naming and tagging the voice notes and aiding in their retrieval from the memory 38. For example, a note can be made on the headset 30 at a location that is recognized as ‘home’ with a trigger set for playback at a geographical location recognized as ‘office’. The recorded note is named “HomeTime”. As a further example, a voice note can be saved in particular location, such as a parking lot, with a trigger to play back the voice note when the person returns to the approximate location. The recorded note is named “ParkingLotTime”. The voice note created relates to the car's location, lot 2 aisle 3, and the note's replay is triggered when the user approaches the location at which the note was recorded indicating where the user is parked. Time based triggers for playback can also be set.

The headset 30 has a USB port 52 for charging and enabling USB data connections. For example, when a user is at his computer 56 and wants to charge his headset. He simply plugs the headset 30 into the USB port 60 on his computer 56. Once the headset 30 is plugged into the computer 56, the rechargeable battery 50 starts charging and the headset 30 shows up on the computer 56 as a USB storage device. The user can now browse the contents of the USB storage device and copy files to and from the device using their computer 56 in a conventional manner. The files are preferably stored in a folder called “voice notes”. Inside this folder are files that were created when the user activated the recorder 32 or locator 34 routine. These flies may be copied from the headset 30 and played back on the host computer 56 using any standard audio application such as iTunes™ or Quicktime™ player. A configuration folder preferably contains the configuration information for the headset 30 produced by the headset interface software 58 residing on the computer 58 as described in more detail below. The wireless digital transceiver 54 can also be used to transfer the audio files and associated metal data wirelessly from the headset 30 to the computer 56 through a standard wireless protocol such as Bluetooth.

Headset application or interface software 58 is included on the computer 56 that allows a user to program the headset 30 to perform more detailed functions such as playing certain content at certain locations or setting the time and date when the headset 30 is connected to the computer 56. The headset 30 can be used to ‘sample’ ambient sound, such as a song sample, that can be compared later to a sample database, either on the computer 56 or the Internet, for identification by the software 58 residing on the computer 56. For example, a user can take an audio sample and then later match it to a song the user was listening to. The software can also be configured to makes listening or purchasing recommendations based on the identified song.

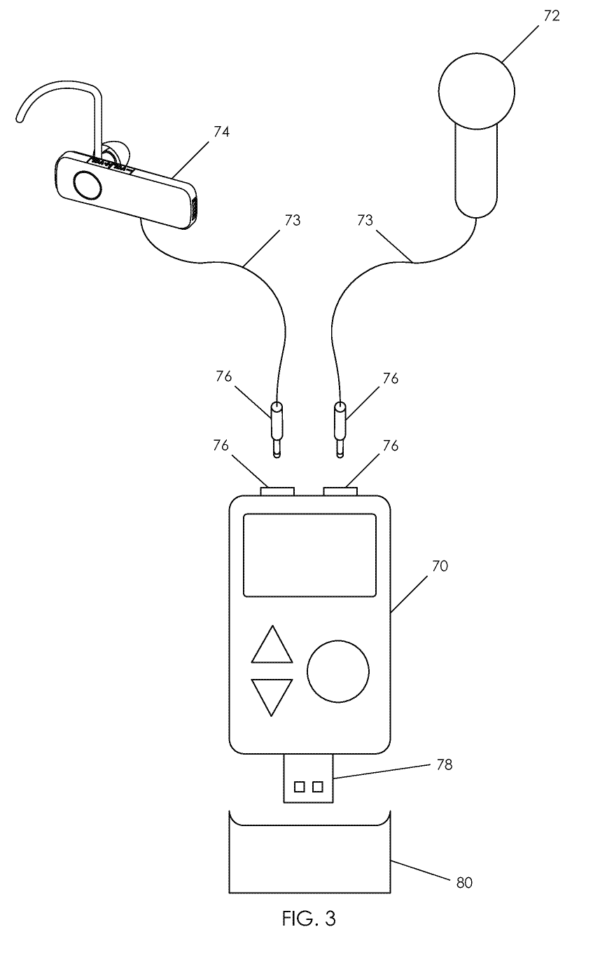

Referring not to FIG. 3, an alternative embodiment of the present invention is shown. The embodiment of FIG. 3 is similar to those described above with a few exceptions. First, the electronics housing 70 has been separated from the microphone 72 and the ear piece 74. In addition, the microphone 72 and earpiece 74 are connected to the electronics housing 70 through cables 73 and jacks 76 for additional flexibility. The housing 70 has an integrated male USB connector 78 that can be plugged directly into a USB port of a computer. When not in use, the connector 78 is covered by a cap 80 that couples to the housing 70. A Female mini USB connector can be used to allow for a smaller housing at the sacrifice of the direct connection to the computer.

Although there have been described particular embodiments of the present invention of a new and useful WIRELESS HEADSET WITH RECORD FUNCTION, it is not intended that such references be construed as limitations upon the scope of this invention except as set forth in the following claims.

What is claimed is:

1. A portable headset that enables wireless two way voice communications between the portable headset and a mobile phone, said portable headset comprising:
an ear grip that grips an ear of a user;
a housing mounted on said ear grip;
a microphone positioned on said housing;
a speaker positioned on said housing;
a display on said housing;
a user input mounted on an exterior of said housing; and
a digital memory enclosed with said housing that records audio samples from said microphone in response to a user manipulating said user input.

2. The portable headset of claim 1 further comprising a global positioning system that determines location information corresponding to a recorded audio sample.

3. The portable headset of claim 1 further comprising a clock that generates a time stamp associated with said audio sample.

4. The portable headset of claim 1 further comprising a USB port.

5. The portable headset of claim 4 further comprising a rechargeable battery that can be recharged through said USB port.

6. The portable headset of claim 4 further comprising application software residing on a computer that downloads recorded audio files from said headset to said computer through said USB port.

7. The portable headset of claim 4 wherein said USB port further comprises a male USB connector.

8. A portable headset for recording audio samples, said portable headset comprising:
an earpiece adapted to fit in an ear of a user;
a microphone;
a speaker;
a housing;
a user input mounted on an exterior of said housing;
a wireless transceiver enclosed within said housing that enables two way voice communications between said apparatus and a mobile phone; and
a digital memory enclosed with said housing that records audio samples from said microphone in response to a user manipulating said user input.

9. The portable headset of claim 8 further comprising a global positioning system that determines location information corresponding to a recorded audio sample.

10. The portable headset of claim 8 further comprising a clock that generates a time stamp associated with said audio sample.

11. The portable headset of claim 8 further comprising a USB port that recharges a rechargeable battery in said housing when said USB port is coupled to an external power source.

12. The portable headset of claim 11 further comprising application software residing on a computer that downloads recorded audio files from said headset to said computer through said USB port.

13. The portable headset of claim 8 wherein said microphone and said speaker and removably coupled to said housing through cables and jacks.

14. A portable headset that enables wireless two way voice communications between the portable headset and a mobile phone, said portable headset comprising:
a voice recorder that records an audio sample in response to manipulation of a user input on the headset.

15. The portable headset of claim 14 further comprising a global positioning system that determines location information corresponding to a recorded audio sample.

16. The portable headset of claim 14 further comprising a clock that generates a time stamp associated with said audio sample.

17. The portable headset of claim 14 further comprising a USB port.

18. The portable headset of claim 17 further comprising a rechargeable battery that can be recharged through said USB port.

19. The portable headset of claim 17 further comprising application software residing on a computer that downloads recorded audio files from said headset to said computer through said USB port.

20. The portable headset of claim 15 further comprising a record button.
